(19) United States
(12) Patent Application Publication
(10) Pub. No.: US 2019/0100410 A1
(43) Pub. Date: Apr. 4, 2019

(54) ELEVATOR CAR, ELEVATOR SYSTEM AND METHOD OF MAINTAINING AN ELEVATOR SYSTEM

(71) Applicants: Carlo MEZZADRI, Cassina (IT); Otis Elevator Company, Farmington, CT (US)

(72) Inventors: Carlo Mezzadri, Cernusco sul Naviglio (IT); Ricardo Cano-Torres, Madrid (ES); Gianluca Foschini, Madrid (ES); Juan Jose Fernandez, Madrid (ES); Antonio De Miguel Urquijo, Madrid (ES); Jose Luis Hortelano, Madrid (ES); Andres Monzon, Madrid (ES); Rosa Querejeta-Marco, Madrid (ES); Raul Gomez, Madrid (ES)

(21) Appl. No.: 16/085,906

(22) PCT Filed: Mar. 18, 2016
(86) PCT No.: PCT/EP2016/056023

§ 371 Date: Sep. 17, 2018

(51) Int. Cl. B66B 11/02; B66B 5/00

(52) U.S. Cl. CPC B66B 11/0246; B66B 5/0087

(57) ABSTRACT

An elevator car (4) comprises at least two maintenance openings (14, 16): an overhead maintenance opening (14) provided in the ceiling of the elevator car (4) for providing access to at least one component arranged on top of and/or above the elevator car (4) and a lateral maintenance opening (16) provided in one sidewall (18) of the car for providing access to at least one component arranged besides the elevator car (4).

The invention relates to an elevator car, in particular to an elevator car with maintenance openings, an elevator system comprising such an elevator car, and to a method of maintaining such an elevator system.

Elevator cars may be provided with a maintenance opening for allowing access from inside the car to functional components of the elevator system in the hoistway. When these functional components are arranged at different heights within the hoistway, it is necessary to move the elevator car or to leave the elevator car for accessing all components and it is usually not possible to simultaneously access a plurality of different functional components.

It therefore would be beneficial to provide an improved elevator car, an elevator system comprising such an improved elevator car, and a method of maintaining such an elevator system which allows facilitating the maintenance of the elevator system.

According to an exemplary embodiment of the invention an elevator car comprises at least two maintenance openings including an overhead maintenance opening provided in the ceiling of the car for providing access to at least one component which is arranged on top of and/or above the elevator car; and a lateral maintenance opening provided in one sidewall of the car for providing access to at least one component which is arranged besides the elevator car.

In an exemplary embodiment of the invention an elevator system comprises at least one elevator car which is movable along a hoistway and comprises at least two maintenance openings including an overhead maintenance opening and a lateral maintenance opening, wherein the overhead maintenance opening provides access to at least one component which is arranged on top and/or above of the elevator car and the lateral maintenance opening provides access to at least one component which is arranged besides the elevator car.

A method of maintaining such an elevator system comprises the steps of: moving the elevator car to a maintenance position; opening the overhead maintenance opening provided in the ceiling of the car for accessing at least one component arranged on top of and/or above the elevator car; and/or opening the lateral maintenance opening provided in one sidewall of the car for accessing at least one component arranged besides the elevator car. The at least one component in particular may include at least one of an elevator drive and a suspension means termination arranged on top of, above and/or besides the elevator car.

An elevator car according to an exemplary embodiment of the invention comprising at least two maintenance openings provides simultaneous access to components of the elevator system which are provided at the rear side of the elevator car as well as to components of the elevator system which are arranged above the elevator car. In an elevator system with such an elevator car different components of the elevator system may be accessed without moving the elevator car and/or leaving the elevator car. As a result, there is no need for moving the elevator car between two or more different maintenance positions and the maintenance and repair of the elevator system are facilitated and the risk of accidents is reduced.

Exemplary embodiments of the invention are described in the following with reference to the enclosed figures:

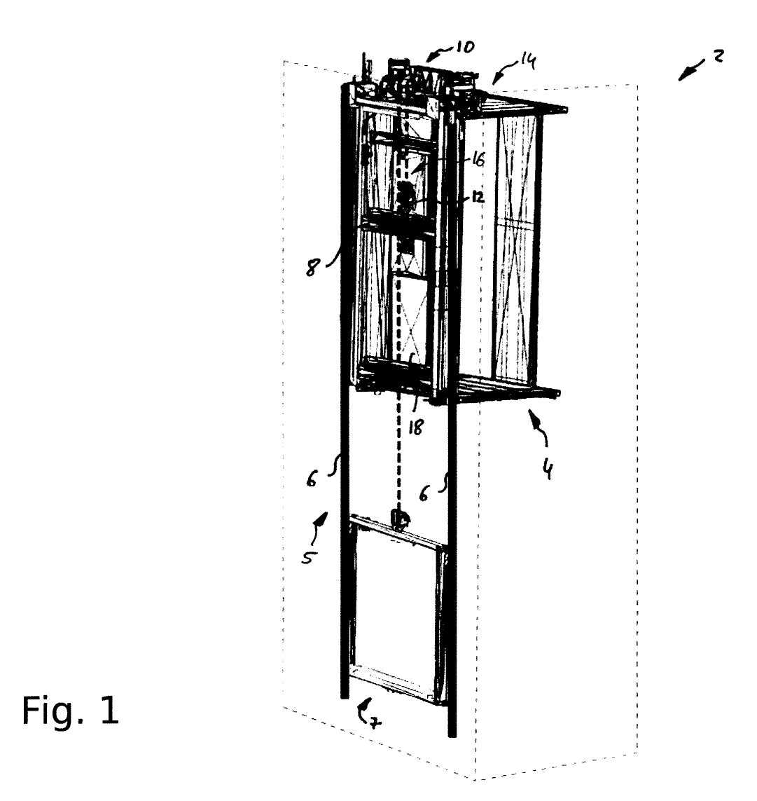

FIG. 1 shows a perspective view of components of an elevator system using a 1:1 roping comprising an elevator car according to a first exemplary embodiment.

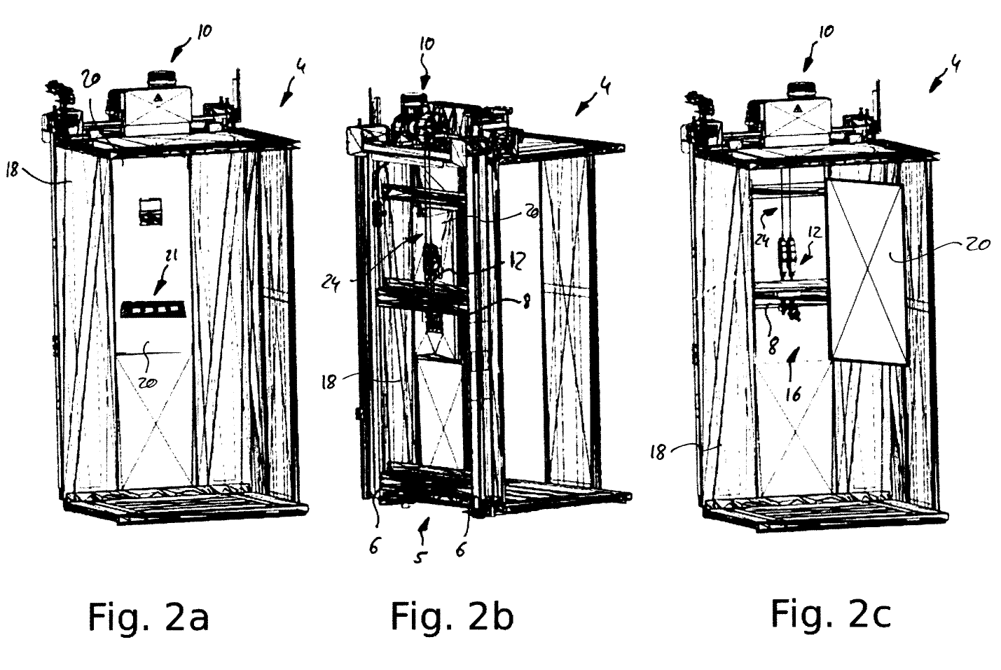

FIGS. 2a to 2c show perspective views of the rear wall of an elevator car according to the first exemplary embodiment.

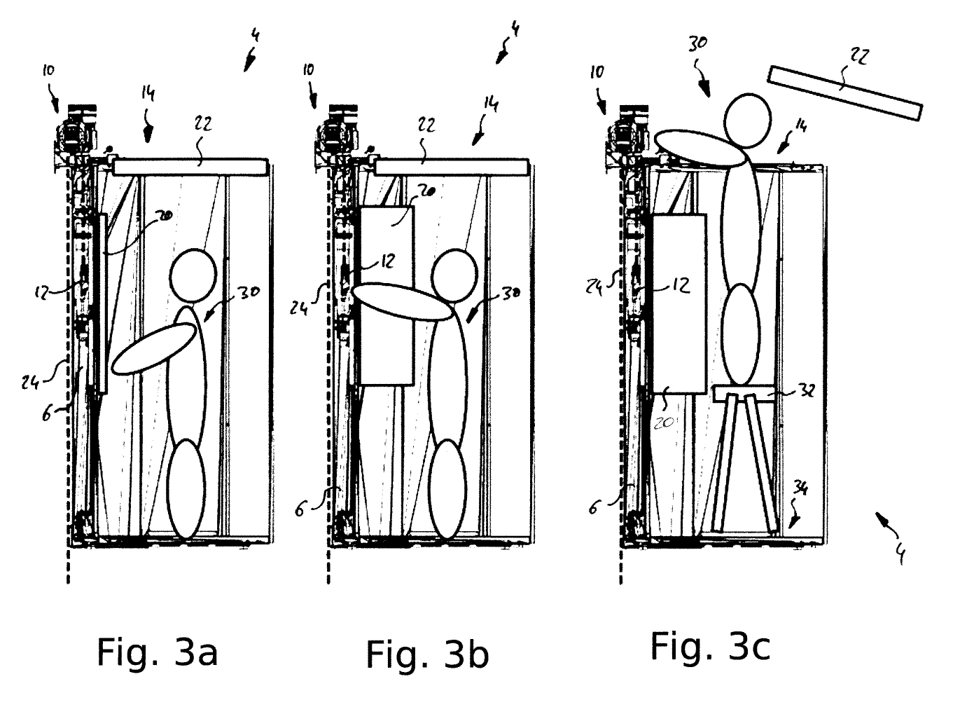

FIGS. 3a to 3c show schematic sectional views of an elevator car according to the first exemplary embodiment.

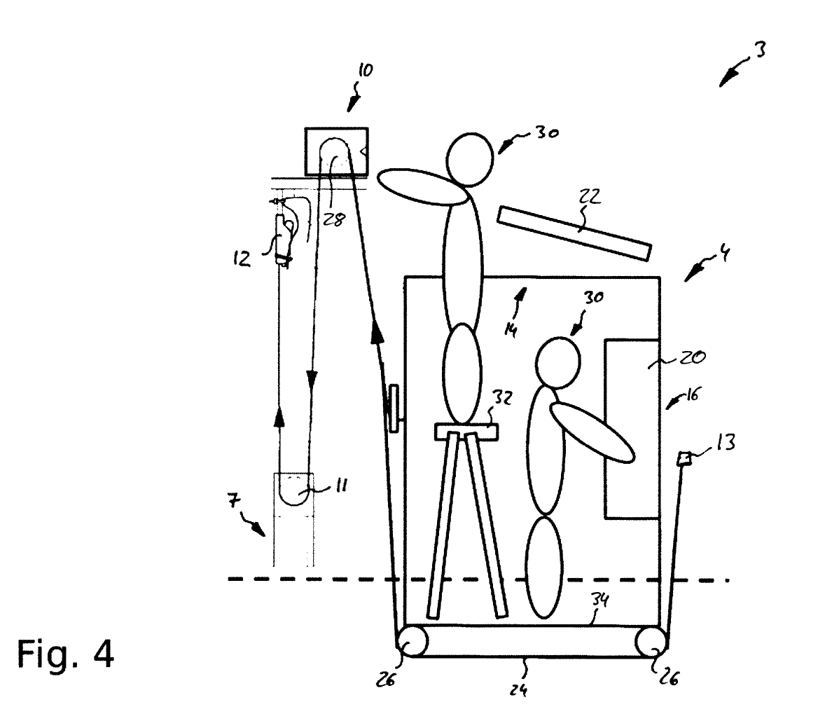

FIG. 4 shows a schematic sectional view of an elevator system with a 2:1 roping comprising an elevator car according to a second exemplary embodiment.

FIG. 1 shows a perspective view of components of an elevator system 2 according to a first exemplary embodiment using a 1:1 roping. The elevator system 2 comprises a frame 5 with two vertically extending guide rails 6, which is configured to be arranged in a hoistway (not shown), and an elevator car 4 which is configured to move in a vertical direction along the length of the guide rails 6.

FIG. 1 depicts a configuration with a cantilever suspension of the elevator car 4. In this configuration the elevator car 4 is suspended by the frame 5 and guided by the guide rails 6. It is to be understood that exemplary embodiments may also include other configurations, e.g. elevator systems (not shown) in which the elevator car 4 is suspended and/or guided centrally.

The elevator car 4 is suspended by means of at least one suspension means (not shown), e.g. a rope or belt. The suspension means extends from a first end, which is attached to the elevator car 4, over an elevator drive 10, which is arranged on top of the frame 5, to a movable counterweight 7, which is attached to an end of the suspension means opposite to the elevator car 4. The counterweight 7 is movable along the length of the guide rails 6 in a direction opposite to the movement of the elevator car 4. The elevator drive 10 is configured for driving the suspension means in order to move the elevator car 4 and the counterweight 7 along the length of the guide rails 6.

The rear side of the elevator car 4 facing the frame 5 is provided with a basically horizontally extending cross beam 8. A suspension means connection point 12, which is configured for connecting an end of the suspension means (not shown) with the elevator car 4, is provided at the cross beam 8.

An overhead maintenance opening 14 is formed in the ceiling of the elevator car 4, and a lateral maintenance opening 16 is formed in a rear wall 18 of the elevator car 4 facing the frame 5.

The two openings 14, 16 provide simultaneous access to the elevator drive 10 arranged on top of the frame 5 and to the suspension means connection point 12 formed at the cross beam 8 on the rear side of the elevator car 4.

This is illustrated in more detail in FIGS. 2a to 2c, respectively depicting an enlarged perspective view of the rear wall 18 of an elevator car 4 according to an exemplary embodiment. FIGS. 2a and 2c show the rear wall 18 from inside the elevator car 4. FIG. 2b shows the rear wall 18 and the adjacent frame 5 from outside the elevator car 4.

In FIGS. 2a and 2b the lateral maintenance opening 16 provided in the rear wall 18 is closed by a rear door 20, which in the exemplary embodiment shown in the figures includes an elevator car control panel 21.

As shown in FIG. 2c, the rear door 20 is pivotable about a vertical axis (not shown). This pivoting motion allows to open the lateral maintenance opening 16 providing access to the cross beam 8, the suspension means connection point 12 and the suspension means 24 which are arranged outside the rear wall 18 of the elevator car 4. It also provides access to the frame 5 and to the guide rails 6 in the hoistway. In an alternative embodiment, which is not shown in the figures, the rear door 20 may be provided as a flap which is pivotable about a horizontally extending axis provided at the upper or lower edge of the first opening 14.

Providing a lateral maintenance opening 16 in the rear wall 18 of the elevator car 4 considerably facilitates the maintenance of the components arranged outside the rear wall 18 of the elevator car 4. In particular, a mechanic, which is not shown in FIGS. 2a to 2c, does not need to leave the elevator car 4 and enter the hoistway for accessing these components. This reduces the risk of accidents and thus enhances the safety of the mechanic during repair and maintenance.

Integrating the elevator car control panel 21 with the rear door 20 provides easy access to the rear side of the control panel 21 by opening the rear door 20, as illustrated in FIG. 2c. It also avoids a degeneration of the optical impression of the interior of the elevator car 4 by the rear door 20.

FIGS. 3a to 3c are schematic illustrations showing cross sectional views of an elevator car 4 according to an exemplary embodiment which is positioned at or close to its topmost position within the hoistway i.e. near the upper end of the frame 5 close to the elevator drive 10 provided on top of the frame 5.

As illustrated in FIG. 3b, a mechanic 30 may open the rear door 20 for easy access to the suspension means connection point 12 provided at the rear side of the elevator car 6, as it has been described with respect to FIGS. 2a to 2c.

During normal operation, i.e. when the elevator system 2 is used for the transportation of passengers, the overhead maintenance opening 14 provided in the ceiling of the elevator car 4 is closed by means of an overhead flap or door 22, which in particular may be a trap door or a folding door.

For maintenance and/or repair, said overhead flap or door 22 may be opened, as it is shown in FIG. 3c, providing access to the elevator drive 10 arranged on top of the frame 5.

By opening the rear door 20 and the overhead flap or door 22 at the same time, the mechanic 30 is provided with simultaneous access to the suspension means connection point 12 provided at the rear side the elevator car 4 as well as to the elevator drive 10 arranged on top of the frame 5 without the need for moving the elevator car 4 between two different positions along the height of the hoistway.

The elevator car 4 may be provided with a platform 32, which is raisable from a retracted position at the bottom 34 of the elevator car 4 to an elevated position, as it is shown in FIG. 3c. In its elevated position, which is shown in FIG. 3c, the platform 32 allows the mechanic 30 to access the elevator drive 10 for maintenance or repair through the overhead maintenance opening 14 without the need of using a ladder or a similar device for reaching out of the overhead maintenance opening 14.

In a further configuration, which is not shown in the figures, the overhead flap or door 22 may be replaced by a platform, which is movable in a vertical direction down into the elevator car 4 for supporting the mechanic 30 at a height which allows him to access the elevator drive 10 through the overhead maintenance opening 14.

The first exemplary embodiment shown in FIGS. 1 to 3c relates to an elevator system 2 using a 1:1 roping.

Exemplary embodiments, however, similarly may be employed in combination with a 2:1 roping. An example of such a configuration is illustrated in a second embodiment, which is shown in FIG. 4.

FIG. 4 shows a schematic sectional view of an exemplary embodiment of an elevator system 3 employing a 2:1 roping. In this embodiment the elevator drive 10 is arranged within the hoistway and the suspension means 24 extends from a first suspension means connection point 12, which is stationary arranged at an upper end of the hoistway, over an idler sheave 11, which is placed on the counterweight 7, a traction sheave 28 of the elevator drive 10, which is arranged at an upper end of the hoistway, and two car pulleys 26, which are fixed to the elevator car 4 below its bottom 34, to a second suspension means connection point 13, which is stationary arranged within the hoistway. In an alternative configuration, which is not shown in the figures, at least one of the car pulleys 26 may be arranged besides the elevator car 4.

In further configurations, which are not shown in the figures, the drive 10 with the traction sheave 28 may be arranged in a lower portion of the hoistway. The elevator car 4 may be suspended centrally. Alternatively, it may be cantilever suspended, as in the first embodiment shown in FIG. 1.

As shown in FIG. 4, providing the elevator car 4 with an overhead maintenance opening 14 and a lateral maintenance opening 16 according to exemplary embodiments allows the mechanic 30 to simultaneously access the first suspension means connection point 12 and the traction sheave 28, which are arranged close to an upper end of the hoistway, and the second suspension means connection point 13, which is arranged at a height well below the first suspension means connection point 12 and the traction sheave 28, without moving the elevator car 4.

As it is not necessary to arrange the first and second suspension means connection points 12, 13 and the traction sheave 28 at the same height for allowing access to both suspension means connection points 12, 13 and the traction sheave 28 via the overhead maintenance opening 14, the length of the suspension means 24 may be reduced by a length which corresponds to the difference in height between the first and second suspension means connection points 12, 13. Typically this length is in the range of one to two meters.

The exemplary embodiments shown in the figures illustrate that the invention considerably facilitates the maintenance of an elevator system 2, 3. In addition, as the length of the suspension means 24 may be reduced, the costs of the installation may be reduced as well.

A number of optional features are set out in the following. These features may be realized in particular embodiments, alone or in combination with any of the other features.

In an embodiment at least one of the openings may be provided with a movable element. The movable element is movable between a closed position closing the respective opening and an open position in which it allows access through the respective opening. Providing such a movable element allows closing the opening(s) in normal operation in order to prevent unauthorized access to the components of the elevator system located within the hoistway outside the elevator car. It further prevents passengers from reaching out of the elevator car into the hoistway. The movable element(s) may be provided with a mechanical or electrical lock in order to prevent an unauthorized opening of the movable element(s).

In an embodiment the at least one movable element may comprise a flap, a door, in particular a folding door or a trap door.

In an embodiment the overhead maintenance opening may be provided with a movable platform providing a stage for supporting a person reaching through the overhead maintenance opening. The movable platform in particular may be movable into a closed position in which it closes the overhead maintenance opening, thereby combining the functionalities of the movable platform with the movable element closing the overhead maintenance opening.

Such platform allows a person, in particular a qualified mechanic, to access components of the elevator system for maintenance or repair through the overhead maintenance opening without using a ladder or a similar device for reaching out of the overhead maintenance opening. It thereby facilitates the maintenance and improves the safety, as there is no need for the mechanic to step on unsafe devices for reaching through the overhead maintenance opening.

In an embodiment an elevator control panel may be provided in front of the lateral maintenance opening. The elevator control panel in particular may be integrated into a door which is movable between a closed position covering the lateral maintenance opening, and an open position providing access to the lateral maintenance opening. Integrating the elevator control panel into the door covering the lateral maintenance opening provides a space saving structure which does not degenerate the interior design of the elevator car. It further provides easy access to the rear side of the elevator control panel by opening the door.

In an embodiment of an elevator system, the overhead maintenance opening and/or the lateral maintenance opening may provide access to a suspension means, in particular the terminations of a suspension means, suspending the elevator car within the hoistway. This allows easy access to the suspension means, in particular terminations of a suspension means, for maintenance and/or repair without the need for leaving the elevator car. In addition, no additional entrance for entering into the hoistway from outside needs to be provided. This reduces the costs of the elevator system.

In an embodiment the elevator system may employ a 1:1 roping, wherein the elevator car comprises a suspension means termination connection point, which is configured for receiving and fixing one end of the suspension means. In such a configuration the suspension means termination connection point may be accessible via the lateral maintenance opening. This allows easy access to the suspension means termination connection point for maintenance and/or repair without the need for leaving the elevator car. In addition, no additional entrance for entering into the hoistway from outside needs to be provided. This reduces the costs of the elevator system.

In an embodiment the elevator system may employ a 2:1 roping, wherein a suspension means termination connection point, which is configured for receiving and fixing one end of the suspension means, is provided in the hoistway. In such a configuration the suspension means termination connection point, idler sheaves and/or pulleys, which are provided for guiding the suspension means, may be accessible via the lateral maintenance opening when the elevator car is positioned in an appropriate maintenance position within the hoistway. This allows easy access to the suspension means termination connection point, idler sheaves and/or pulleys for maintenance and/or repair without the need for leaving the elevator car. In addition, no additional entrance for entering into the hoistway from outside needs to be provided. This reduces the costs of the elevator system.

In an embodiment of an elevator system, the overhead maintenance opening may provide access to an elevator drive, which is provided in the hoistway, in particular at an upper end of the hoistway, for moving the elevator car. This allows easy access to the elevator drive for maintenance and/or repair without the need for leaving the elevator car. In addition, no additional entrance for entering into the hoistway from outside needs to be provided. This reduces the costs of the elevator system.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention not be limited to the particular embodiment disclosed, but that the invention include all embodiments falling within the scope of the claims.

### REFERENCES

2 elevator system (first embodiment)

3 elevator system (second embodiment)

4 elevator car

5 frame

6 guide rails

7 counterweight

8 crossbeam

10 elevator drive

11 idler sheave

12 (first) suspension means connection point

13 second suspension means connection point

14 overhead maintenance opening

16 lateral maintenance opening

18 sidewall of the elevator car

20 rear door

21 control panel

22 trap door

24 suspension means

26 car pulley

28 traction sheave

30 mechanic

32 platform

34 bottom of the elevator car

1. Elevator car (4) comprising at least two maintenance openings (14, 16) including:
an overhead maintenance opening (14) provided in the ceiling of the elevator car (4) for providing access to at least one component arranged on top and/or above of the elevator car (4); and
a lateral maintenance opening (16) provided in one sidewall (18) of the car for providing access to at least one component arranged besides the elevator car (4).

2. Elevator car (4) according to claim 1, wherein at least one of the maintenance openings (14, 16) is provided with a movable element (20, 22), which is movable between a closed position closing the respective maintenance opening (14, 16) and an open position in which it allows access through the respective maintenance opening (14, 16).

3. Elevator car (4) according to claim 2, wherein the at least one movable element (20, 22) comprises a flap, a door or a trap door.

4. Elevator car (4) according to claim 1, provided with a movable platform (32) providing a stage for supporting a person (30) reaching through the overhead maintenance opening (14).

5. Elevator car (4) according to claim 4, wherein the movable platform (32) is movable into a closed position in which it closes the overhead maintenance opening (14).

6. Elevator car (4) according to claim 1, wherein an elevator control panel (20) is provided in front of the lateral maintenance opening (16).

7. Elevator car (4) according to claim 6, wherein the elevator control panel (20) is movable between a closed position covering the lateral maintenance opening (16), and an open position providing access to the lateral maintenance opening (16).

8. Elevator system (2; 3) comprising at least one elevator car (4) according to claim 1 which is movable in a hoistway.

9. Elevator system (2; 3) according to claim 8, wherein, when the elevator car (4) is positioned in an appropriate maintenance position within the hoistway, the overhead maintenance opening (14) and/or the lateral maintenance opening (16) provides access to a suspension means (24), in particular terminations (12) of a suspension means (24), suspending the elevator car (4) within the hoistway.

10. Elevator system (2) according to claim 9 using a 1:1 roping, wherein the elevator car (4) comprises a suspension means termination (12), which is configured for receiving one end of a suspension means (24) supporting the elevator car (4), wherein the suspension means termination (12) is accessible via the lateral maintenance opening (16).

11. Elevator system (3) according to claim 9 using a 2:1 roping, wherein at least one suspension means termination (12), which is configured for receiving one end of a suspension means (24) supporting the elevator car (4), is provided in the hoistway, and wherein the at least one suspension means termination (12) and/or at least one traction sheave (28), which is provided for driving the suspension means, are accessible via the lateral maintenance opening (16) when the elevator car (4) is positioned in an appropriate maintenance position within the hoistway.

12. Elevator system (2; 3) according to claim 8, wherein, when the elevator car (4) is positioned in an appropriate maintenance position within the hoistway, the overhead maintenance opening (14) provides access to an elevator drive (10) provided in the hoistway for moving the elevator car (4).

13. Method of maintaining an elevator system (2, 3) according to claim 8 comprising:
moving the elevator car (4) to a maintenance position;
opening the overhead maintenance opening (14) provided in the ceiling of the elevator car (4) for accessing at least one component arranged on top and/or above of the elevator car (4); and/or
opening the lateral maintenance opening (16) provided in one sidewall (18) of the elevator car (4) for accessing at least one component arranged besides the elevator car (4).

14. Method of claim 13, wherein the at least one component arranged on top and/or above of the elevator car (4) includes at least one of an elevator drive (10) and a suspension means termination (12).

15. Method of claim 13, wherein the at least one component arranged besides the elevator car (4) includes at least one of an elevator drive (10) and a suspension means termination (12).
